(19) United States
(12) Patent Application Publication
(10) Pub. No.: US 2016/0117622 A1
(43) Pub. Date: Apr. 28, 2016

(54) SHARED RISK GROUP MANAGEMENT SYSTEM, SHARED RISK GROUP MANAGEMENT METHOD, AND SHARED RISK GROUP MANAGEMENT PROGRAM

(71) Applicant: NEC CORPORATION, Minato-ku, Tokyo (JP)

(72) Inventor: Yoshiharu MAENO, Tokyo (JP)

(21) Appl. No.: 14/891,392

(22) PCT Filed: Mar. 4, 2014
(86) PCT No.: PCT/JP2014/001180

§ 371 Date: Nov. 16, 2015

(30) Foreign Application Priority Data
May 22, 2013 (JP) 2013-107597

(51) Int. Cl. G06Q 10/06; G06Q 30/02

(52) U.S. Cl. CPC G06Q 10/0635; G06Q 30/0206

(57) ABSTRACT

Provided are a service influence degree calculation unit 11 that calculates a service influence degree that is a degree of an influence imposed on each service by a risk factor which is likely to influence execution of the service, the service influence degree calculated for each of the risk factor, a risk factor distance calculation unit 12 that calculates a distance between risk factors for indicating a similarity between risk factors based on the service influence degree for each of the risk factors, a shared risk group determination unit 13 that determines a group of risk factors which has the distance between risk factors meeting a first condition, as a shared risk group, and a shared risk group removal determination unit 14 that determines a shared risk group meeting a second condition from the shared risk groups, as a shared risk group to be removed.

### 1. TECHNICAL FIELD

The present invention relates to a shared risk group management system, a shared risk group management method, and a shared risk group management program.

### 2. BACKGROUND ART

There is a method which uses a mathematical model to analyze availability, such as an operating ratio and a failure repair time, of a cloud data center or other information systems providing online supply of server infrastructure constituted by virtual machines and physical servers to a number of tenant companies.

PTLs 1 to 4 describe examples of technologies associated with a system for managing a general availability prediction model. The availability prediction model includes various information concerning a mathematical model for calculating, verifying, and analyzing availability, calculation formulae, parameters, and structures and operations of the system. A basic function of availability prediction is prediction of an operating ratio of the entire system.

PTL 1 discloses a method which predicts an operating ratio of an entire system based on characteristics such as a ratio of occurrence of failure in each of computers constituting the system, and a time required for repair of failure, and based on monitoring information about failure during operation.

PTL 2 discloses a method which synthesizes a fault tree (Fault Tree) based on system configuration information about software and hardware to determine failure with reference to the fault tree, and then calculates a failure ratio to analyze whether or not the calculated failure ratio meets a reference value.

PTL 3 discloses a method which registers information about availability and other information such as functions, configurations, security, and performance as metadata at the time of installation of an application program or an application service, and uses the data for later analysis of configuration management, failure detection, diagnosis, repair or the like.

PTL 4 discloses a method which stores a period of continuation of failure, and the number of users unable to use services due to the failure for each occurrence of failure, and accumulates these data to estimate a ratio of a failure time, a ratio of damage caused by failure per one user, an operating ratio, and others.

Particularly, there is a method widely known in the field of hardware which analyzes likelihood of failure of an entire system based on characteristics of parts by using a mathematical model such as a fault tree.

In the field of software, there is a method which describes state transitions by using a mathematical model such as stochastic petri network (Stochastic Petri Network) and stochastic reward network (Stochastic reward network), and simulates the transitions to reproduce the transitions for availability analysis.

Availability (Availability) is an index concerning performance of a system for indicating a ratio of availability of a service by a user in a certain period. Availability is used as a synonym for an operating ratio.

For example, availability of a case containing a mean unavailable time zone of 1 minute per day is calculated as 1−1÷(24×60)=99.93%. In general, availability is determined based on a time interval between occurrences of failure (Mean Time Between Failure) and a time until repair from failure (Mean Time To Repair).

FIG. 12 depicts an example of calculation and verification of availability based on an ordinary prediction model by using a technology of stochastic petri network or stochastic reward network. FIG. 12 is an explanatory view depicting an example of stochastic petri network for calculation and verification of availability based on an availability prediction model. FIG. 12 depicts an example of stochastic petri network for defining states, transitions between states, and conditions required for transitions.

According to an information system in the example depicted in FIG. 12, it is assumed that an application AP operates under a virtual server (virtual machine (Virtual Machine, hereinafter referred to as VM as well) VM, and that the virtual server VM operates under a physical server PM.

Rounded squares depicted in FIG. 12 indicate respective states of the physical server, the virtual server, and the application. There are defined in FIG. 12, normal driving states of “physical server in operation”, “virtual server in operation”, and “application in operation”, and failure states of “physical server under suspension”, “virtual server under suspension”, and “application under suspension”.

The virtual server in the example depicted in FIG. 12 is not a hypervisor corresponding to a control program of a virtual server accessible only by a data center administrator, but an ordinary virtual server allocated to and accessible by a user, i.e., a user VM. The physical server in the example depicted in FIG. 12 is a physical computer environment where the virtual server is executed.

Each of transitions in the stochastic petri network depicted in FIG. 12 is expressed by a rectangle indicating an event causing the transition and transition likelihood of the transition, and by an arrow indicating a transition direction.

For example, the state “virtual server in operation” switches to the state “virtual server under suspension” at transition likelihood 1 during suspension of the physical server, and at transition likelihood μ_{VM} in a period other than suspension of the physical server. The state “virtual server under suspension” switches to the state “virtual server in operation” at transition likelihood λ_{VM} during operation of the physical server, and at transition likelihood 0 in a period other than operation of the physical server.

The user using the stochastic petri network is capable of analyzing availability based on simulation for reproduction of transitions. Accordingly, the user is capable of calculating a value of availability based on the likelihood of the transition to the state of “application under suspension” after an elapse of a sufficient time.

In the simplest view, the state of “application under suspension” is regarded as a failure. However, states of the application other than the suspension state may be regarded as a failure. Values of availability are variable depending on definition of a failure or definition of an operation.

The data center administrator produces respective states and respective transitions described in the stochastic petri network while considering the characteristics of server infrastructure and the data center operational procedures concerning the server infrastructure. That is, there may be produced various types of availability prediction models in correspondence with operation procedures.

### CITATION LIST

### Patent Literatures

PTL 1: JP 2008-532170 A

PTL 2: JP 2006-127464 A

PTL 3: JP 2007-509404 A

PTL 4: JP 2005-080104 A

### SUMMARY OF INVENTION

### Technical Problem

At the time of planning of shared risk removal for improving availability, simultaneous removal of other shared risks influencing execution of a service needs to be considered in view of execution of a user service so as to increase reliability of the service, as has been a problem arising from the methods described in PTLs 1 to 4.

This necessity comes from the following reason. Removal of a shared risk is substantially achievable by realizing redundancy of a device or switching a device to another highly reliable device. However, a plurality of other shared risks may be associated with a targeted shared risk. For example, there is such a case that operation of a virtual server is needed as well as operation of a physical server for execution of a user service. Accordingly, simultaneous removal of the foregoing other shared risks is required as well in some cases.

In consideration of these circumstances, there are provided according to the present invention, a shared risk group management system, a shared risk group management method, and a shared risk group management program, which are capable of measuring similarities between risk factors as distances, determining a group of risk factors meeting predetermined conditions based on the measured distances, and managing the determined group as a shared risk group to be removed.

### Solution to Problem

A shared risk group management system according to the present invention includes: a service influence degree calculation unit that calculates a service influence degree that is a degree of an influence imposed on each service by a risk factor which is likely to influence execution of the service, the service influence degree calculated for each of the risk factors; a risk factor distance calculation unit that calculates a distance between risk factors for indicating a similarity between risk factors based on the service influence degree for each of the risk factors; a shared risk group determination unit that determines a group of risk factors which has the distance between risk factors meeting a first condition, as a shared risk group; and a shared risk group removal determination unit that determines a shared risk group meeting a second condition from the shared risk groups, as a shared risk group to be removed.

A shared risk group management method according to the present invention includes: calculating a service influence degree that is a degree of an influence imposed on each service by a risk factor which is likely to influence execution of the service, the service influence degree calculated for each of the risk factors; calculating a distance between risk factors for indicating a similarity between risk factors based on the service influence degree for each of the risk factors; determining a group of risk factors which has the distance between risk factors meeting a first condition, as a shared risk group; and determining a shared risk group meeting a second condition from the shared risk groups, as a shared risk group to be removed.

A shared risk group management program according to the present invention is a program that causes a computer t to execute: a service influence degree calculation process that calculates a service influence degree that is a degree of an influence imposed on each service by a risk factor which is likely to influence execution of the service, the service influence degree calculated for each of the risk factors; a risk factor distance calculation process that calculates a distance between risk factors for indicating a similarity between risk factors based on the service influence degree for each of the risk factors; a shared risk group determination process that determines a group of risk factors which has the distance between risk factors meeting a first condition, as a shared risk group; a shared risk group removal determination process that determines a shared risk group meeting a second condition from the shared risk groups, as a shared risk group to be removed.

### Advantageous Effects of Invention

According to the present invention, similarities between risk factors are measured as distances, a group of risk factors meeting predetermined conditions based on the measured distances are determined, and the determined group is managed as a shared risk group to be removed.

### BRIEF DESCRIPTION OF DRAWINGS

FIG. 1 It depicts a block diagram depicting a configuration example of a shared risk group management system 100.

FIG. 2 It depicts a flowchart depicting an operation of a shared risk group removal determining process executed by the shared risk group management system 100 according to a first exemplary embodiment.

FIG. 3 It depicts an explanatory view depicting an example of an information system including virtual servers.

FIG. 4 It depicts an explanatory view depicting an example of risk factor information.

FIG. 5 It depicts an explanatory view depicting an example of target device characteristic information.

FIG. 6 It depicts an explanatory view depicting an example of user service characteristic information.

FIG. 7 It depicts an explanatory view depicting an example of service influence degree information.

FIG. 8 It depicts an explanatory view depicting an example of risk factor distance information.

FIG. 9 It depicts an explanatory view depicting an example of shared risk group information.

FIG. 10 It depicts an explanatory view depicting an example of shared risk group information.

FIG. 11 It depicts a block diagram depicting an outline of a shared risk group management system according to the present invention.

FIG. 12 It depicts an explanatory view depicting an example of a stochastic petri network for calculation and verification of availability using an availability prediction model.

### DESCRIPTION OF EMBODIMENTS

### First Exemplary Embodiment

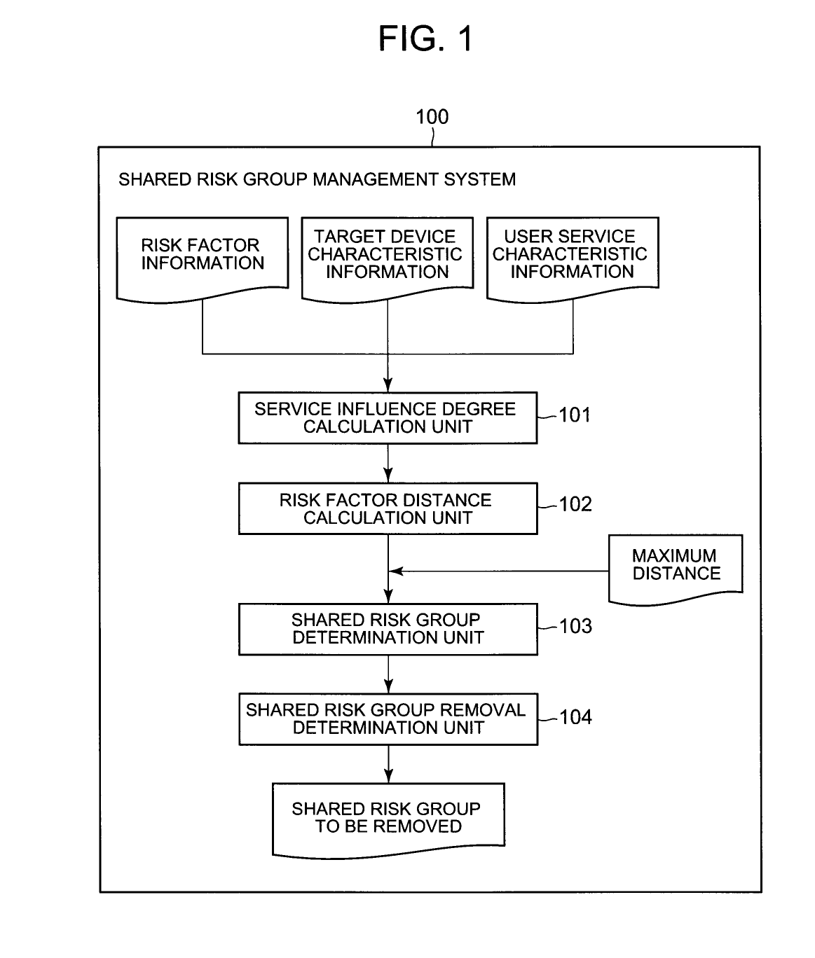

An exemplary embodiment according to the present invention is hereinafter described with reference to the drawings. FIG. 1 is a block diagram depicting a configuration example of a shared risk group management system 100. The shared risk group management system 100 depicted in FIG. 1 includes a service influence degree calculation unit 101, a risk factor distance calculation unit 102, a shared risk group determination unit 103, and a shared risk group removal determination unit 104.

The service influence degree calculation unit 101 calculates service influence degree information based on risk factor information, target device characteristic information, and user service characteristic information.

The risk factor information includes items of “device corresponding to risk factor”, “device influenced by risk factor”, and “cost for risk factor removal” for each risk factor.

The risk factor information may be stored in a relational database (relational database) as a table. The risk factor information may be stored in a file in text format.

An administrator is allowed to sequentially add a new item to the risk factor information. Moreover, the administrator is allowed to delete or correct items already included.

The “device corresponding to risk factor” indicates a device causing a failure which is likely to become a risk factor. The “device influenced by risk factor” includes a virtual server and a router as well as a physical server.

Furthermore, the “device corresponding to risk factor” may include an application program and the like, considering an application program as a type of devices. In this case, an identifier described in the “device corresponding to risk factor” is a resource identifier for specifying each device, such as an “identifier of a virtual server”, an “identifier of a router”, and an “identifier of an application program”.

The “cost for risk factor removal” indicates a cost (sum of money) required for removal of a risk factor by realizing redundancy of a device or switching a device to another highly reliable device. In addition, the “cost for risk factor removal” may indicate a time required for work, or the number of engineers required for work, at the time of removal of a risk factor by realizing redundancy of a device or switching a device to another highly reliable device.

The target device characteristic information includes items to be described of “device”, “failure ratio λ” of a device, “repair ratio μ” of a device for each device. The administrator is allowed to sequentially add a new item to the target device characteristic information every time a new device is introduced. At this time, the administrator is allowed to delete or correct items already included.

The “failure ratio λ” of a device indicates likelihood of failure during an individual operation of a device. The “recovery ratio μ” of a device indicates likelihood of repair during an individual operation of a device. Each of the “failure ratio λ” of a device and the “recovery ratio μ” of a device is expressed by a successive real number in a range from 0 to 1.

The target device included in the target device characteristic information is not limited to a physical server, but may be a virtual server, a router, an application program, or others. In this case, an identifier described in the “device” is a resource identifier for specifying each device, such as a physical server, a virtual server, a router, and an application program. The target device characteristic information includes a failure ratio and a repair ratio of a device corresponding to a described resource identifier.

The user service characteristic information includes items of “user service”, and “application program” for each user service. The administrator is allowed to sequentially add a new item at the time of introduction of a new service. At this time, the administrator is allowed to delete or correct items already included.

Contents described in the risk factor information, the target device characteristic information, and the user service characteristic information may be data read via a network based on information set by the administrator. Alternatively, contents described in the risk factor information, the target device characteristic information, and the user service characteristic information may be data directly input by the administrator through a keyboard.

The risk factor distance calculation unit 102 calculates risk factor distance information based on service influence degree information.

The shared risk group determination unit 103 calculates shared risk group information based on the risk factor distance information and a maximum distance. The maximum distance is a positive real number.

The shared risk group removal determination unit 104 determines a shared risk group to be removed based on the shared risk group information. The determined shared risk group to be removed may be shown on a display, or output into a file.

The service influence degree calculation unit 101, the risk factor distance calculation unit 102, the shared risk group determination unit 103, and the shared risk group removal determination unit 104 according to this exemplary embodiment are realized by a CPU (Central Processing Unit) operating under a program, for example. These units may be realized by hardware.

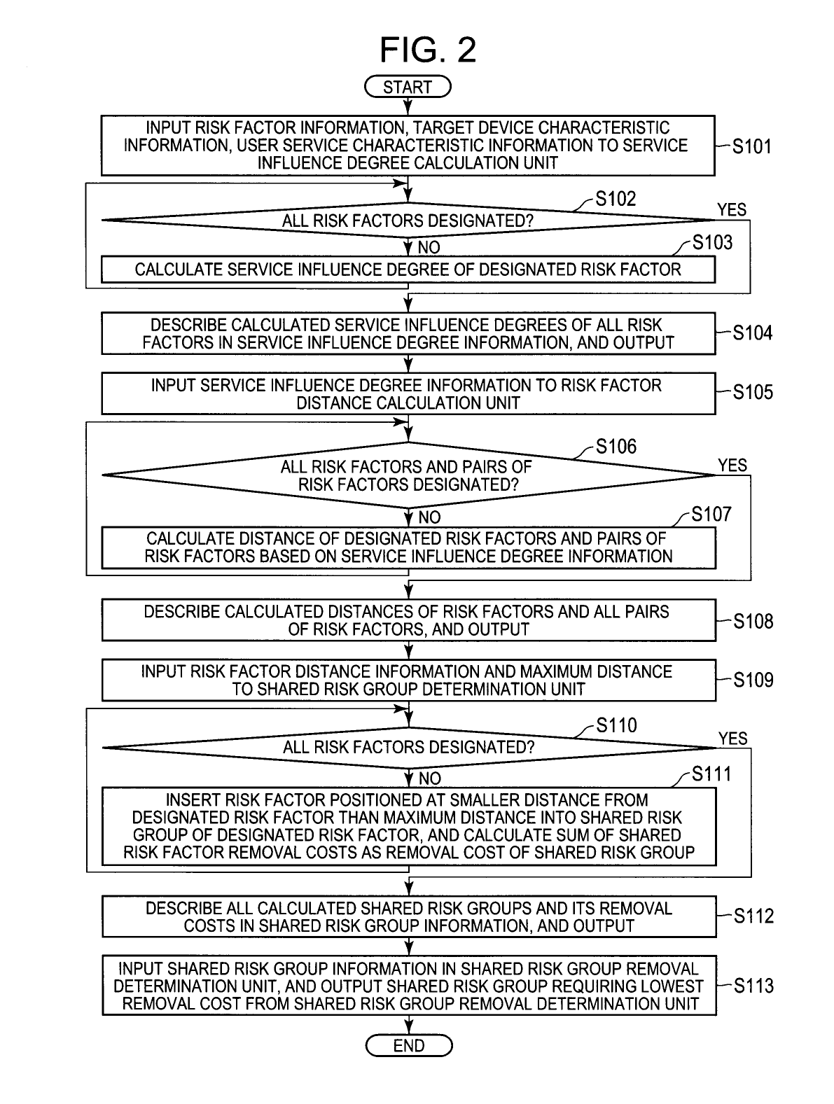

An operation of the shared risk group removal determining process according to this exemplary embodiment is hereinafter described with reference to a flowchart depicted in FIG. 2. FIG. 2 is a flowchart depicting the operation of the shared risk group removal determining process executed by the shared risk group management system 100 according to the first exemplary embodiment.

The service influence degree calculation unit 101 inputs the risk factor information, the target device characteristic information, and the user service characteristic information (step S101). Then, the service influence degree calculation unit 101 checks whether or not all risk factors have been designated (step S102).

When it is determined that all the risk factors have not been designated yet (No in step S102), the service influence degree calculation unit 101 calculates a service influence degree of a risk factor newly designated (step S103). After this calculation, the service influence degree calculation unit 101 again executes the process in step S102.

When it is determined that all the risk factors have been designated (Yes in step S102), the service influence degree calculation unit 101 describes the calculated service influence degrees of all the risk factors in the service influence degree information. After this describing, the service influence degree calculation unit 101 outputs the service influence degree information (step S104).

The service influence degree calculation unit 101 uses Equations (1) to (4) at the time of calculation of the service influence degree information.

When the risk factor is a physical server, the service influence degree calculation unit 101 calculates an application influence degree by using Equation (1).

Application influence degree(PSᵢ→APₖ)=1/Aₛᵢ+1/A_{VMj}+1/A_{APk} Equation (1)

A physical server PSᵢ included in Equation (1) influences all application programs APₖ under the influence of all virtual servers VMⱼ under the influence of the physical server PSᵢ. The service influence degree calculation unit 101 is capable of determining which application program is influenced by a device with reference to a device influenced by a device based on the risk factor information.

In Equation (1), a level of an influence imposed on the application program APₖ by the physical server PSᵢ is expressed as an application influence degree (PSᵢ→APₖ). When the application program is not influenced by the physical server PSᵢ, the application influence degree is set to 0.

When the risk factor is a virtual server, the service influence degree calculation unit 101 calculates an application influence degree by using Equation (2).

Application influence degree(VMⱼ→APₖ)=1/A_{VMj}+1/A_{APk} Equation(2)

In Equation (2), a level of an influence imposed on the application program APₖ by a virtual server VMⱼ is expressed as an application influence degree (VMⱼ→APₖ). When the application program is not influenced by the virtual server VMⱼ, the application influence degree is set to 0.

The reciprocal of an operating ratio A is used in Equation (1) and Equation (2). However, the reciprocal of a repair ratio, or the reciprocal of the harmonic mean of the operating ratio and the recovery ratio may be used instead of the reciprocal of the operating ratio. The administrator may describe, in the target device characteristic information, a mean time interval between failures, a mean recovery time, the number of occurrences of failure, the number of repairs of failure having occurred, and others calculated based on performance up to the present, and use the described values instead of the operating ratio or the recovery ratio.

The service influence degree calculation unit 101 further calculates a service influence degree for each risk factor by using the user service characteristic information and the calculated application influence degrees. The service influence degree calculation unit 101 uses Equation (3) or Equation (4) at the time of calculation of a service influence degree.

$$\begin{matrix} [ Mathematical Formula 1 ] & \\ Service influence degree ( {PS}_{i} \to {SV}_{l} ) = {\sum }_{{\{ All application}_{{AP}_{k} that {SV}_{l} uses \}}} Application influence degree ( {PS}_{i} \to {AP}_{k} ) & Equation ( 3 ) \\ [ Mathematical Formula 2 ] & \\ Service influence degree ( {VM}_{j} \to {SV}_{l} ) = {\sum }_{{\{ All application}_{{AP}_{k} that {SV}_{l} uses \}}} Application influence degree ( {VM}_{j} \to {AP}_{k} ) & Equation ( 4 )\end{matrix}$$

In Equation (3), a level of an influence imposed on a user service SVₗ by the physical server PSᵢ is expressed as a service influence degree (PSᵢ→SVₗ). In Equation (4), a level of an influence imposed on the user service SVₗ by the virtual server VMⱼ is expressed as a service influence (VMⱼ→SVₗ). Information collectively containing service influences for each risk factor calculated based on Equation (3) or Equation (4) corresponds to the service influence degree information.

The risk factor distance calculation unit 102 inputs the service influence degree information (step S105). Then, the risk factor distance calculation unit 102 checks whether or not all risk factors and pairs of risk factors have been designated (step S106).

When it is determined that all the risk factors and pairs of risk factors have not been designated yet (No in step S106), the risk factor distance calculation unit 102 calculates a distance of risk factors and pair of risk factors newly designated from the service influence degree information (step S107).

When it is determined that all the risk factors and pairs of risk factors have been designated (Yes in step S106), the risk factor distance calculation unit 102 describes, in the risk factor distance information, calculated distances between all the risk factors and the pairs of risk factors. After this describing, the risk factor distance calculation unit 102 outputs the risk factor distance information (step S108).

At the time of calculation of a distance between risk factors, the risk factor distance calculation unit 102 is capable of calculating the distance by using a geometrical distance obtained when a service influence degree is regarded as a vector in Euclidean space, a Manhattan distance, or a generalized Mahalanobis' distance, for example.

The shared risk group determination unit 103 inputs the risk factor distance information. The shared risk group determination unit 103 further inputs the maximum distance (step S109). Then, the shared risk group determination unit 103 checks whether or not all the risk factors have been designated (step S110).

When it is determined that all the risk factors have not been designated yet (No in step S110), the shared risk group determination unit 103 checks whether or not a distance between risk factors newly designated is smaller than the maximum distance.

The shared risk group determination unit 103 inserts, into the shared risk group, a risk factor positioned at a smaller distance from a risk factor targeted for generation of a shared risk group than the maximum distance. Then, the shared risk group determination unit 103 calculates a sum of costs for removing shared risk factors contained in the generated shared risk group to obtain a cost for removing the shared risk group (step S111).

When it is determined that all the risk factors have been designated (Yes in step S110), the shared risk group determination unit 103 describes all the shared risk groups and the costs for removing the shared risk groups in the shared risk group information. After this describing, the shared risk group determination unit 103 outputs the shared risk group information (step S112).

The shared risk group removal determination unit 104 inputs the shared risk group information. Then, the shared risk group removal determination unit 104 determines a shared risk group requiring the lowest removal cost (step S113).

After output of the determined shared risk group to be removed, the shared risk group management system 100 ends the shared risk group removal determining process.

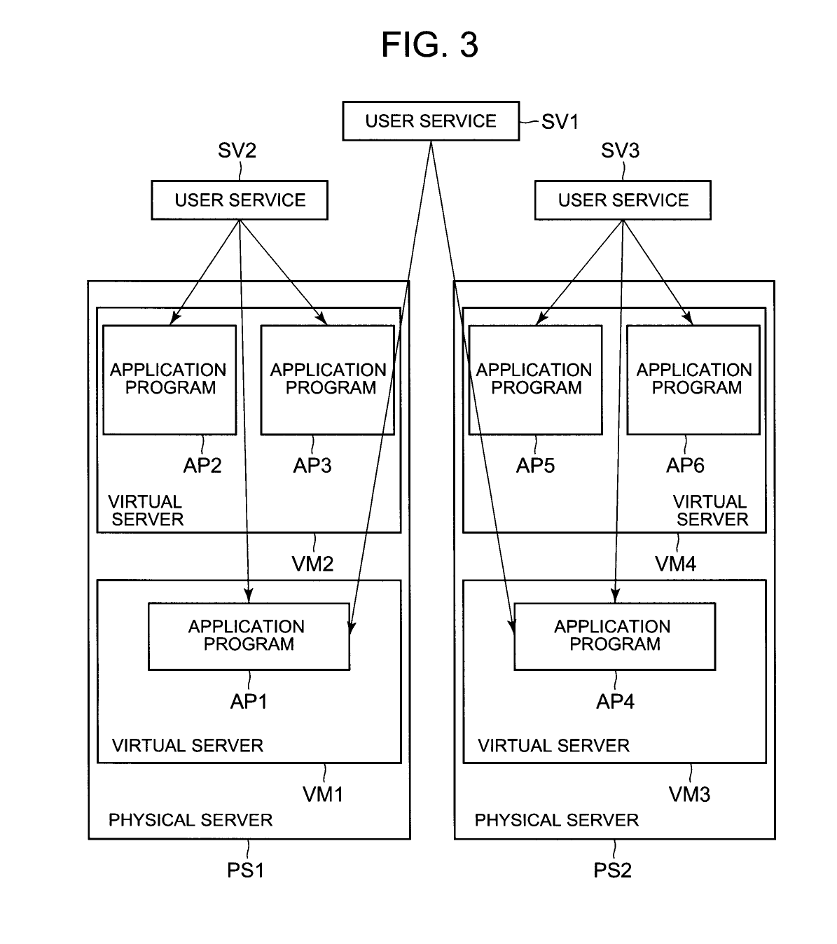

A specific example of the operation of the shared risk group removal determining process according to the present invention is hereinafter described with reference to FIG. 3. FIG. 3 is an explanatory view depicting an example of an information system including virtual servers.

FIG. 3 depicts two physical servers constituted by a physical server PS1 and a physical server PS2. The physical server PS1 includes two virtual servers constituted by a virtual server VM1 and a virtual server VM2. The virtual server VM2 includes an application program AP2 and an application program AP3.

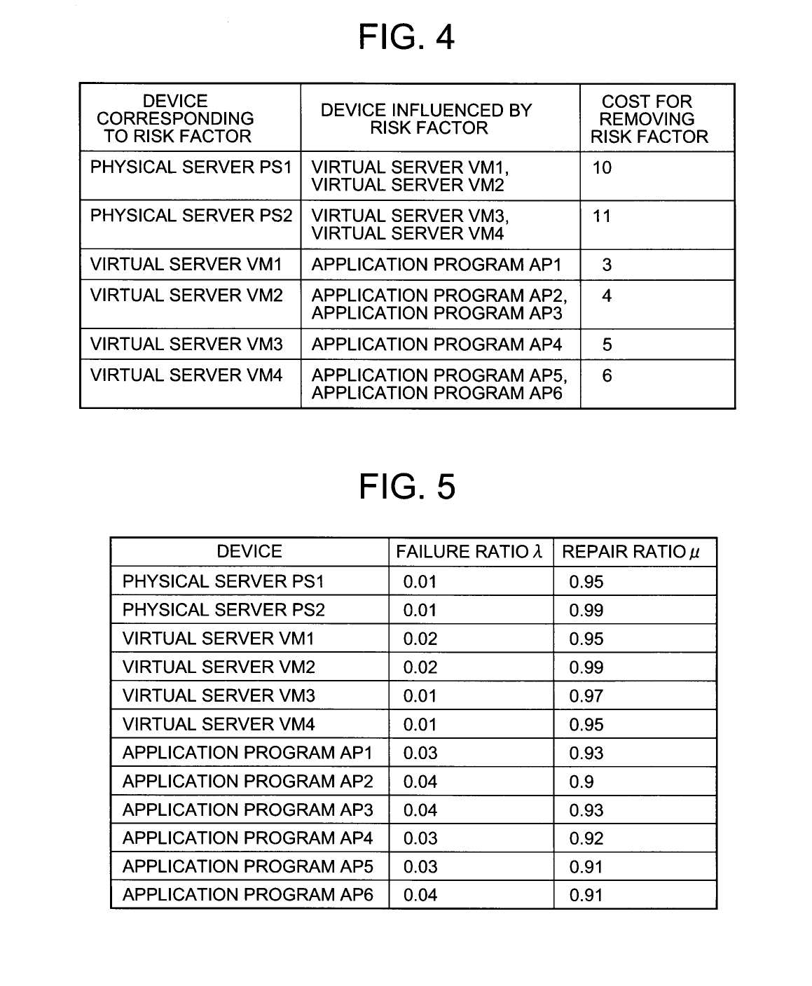

FIG. 4 shows values of risk factor information for the information system depicted in FIG. 3. FIG. 4 is an explanatory view depicting an example of the risk factor information.

Referring to FIG. 4, a removal cost for removing a risk of the physical server PS1 is 10. The physical server PS1 influences the virtual server VM1 and the virtual server VM2 included in the physical server PS1.

FIG. 5 shows values of target device characteristic information for the information system depicted in FIG. 3. FIG. 5 is an explanatory view depicting an example of the target device characteristic information.

Referring to FIG. 5, a failure ratio of the physical server having an identifier of the physical server PS1 is λ=0.01. A recovery ratio of the physical server having an identifier of the physical server PS1 is μ=0.95.

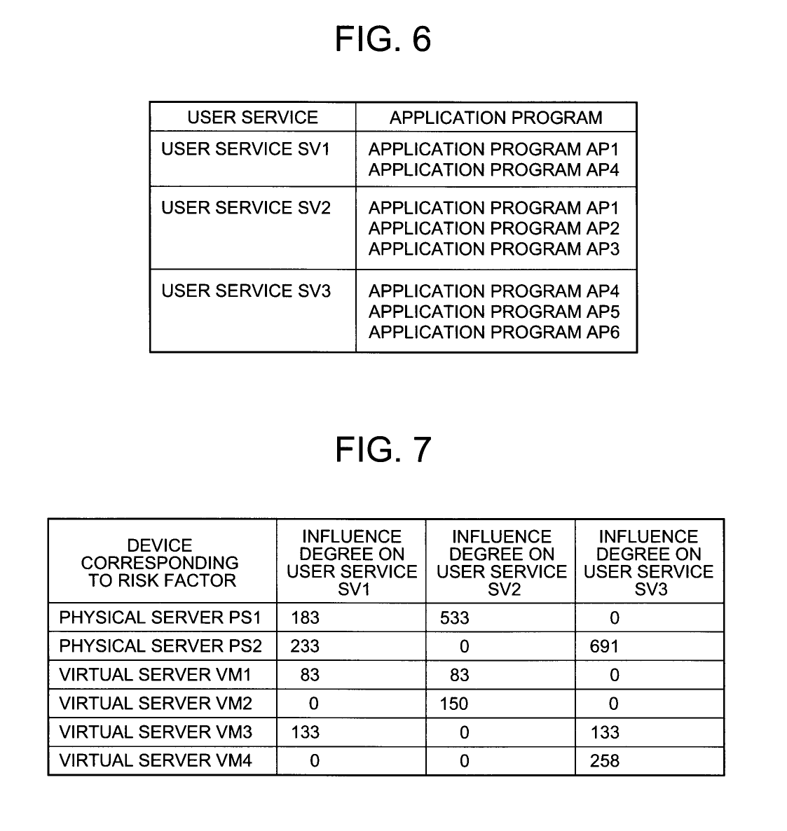

FIG. 6 shows values of user service characteristic information for the information system depicted in FIG. 3. FIG. 6 is an explanatory view depicting an example of the user service characteristic information.

The service influence degree calculation unit 101 calculates a service influence degree for each risk factor based on the information described in FIGS. 4 to 6 by using Equations (1) to (4). After this calculation, the service influence degree calculation unit 101 outputs service influence degree information. FIG. 7 depicts an example of the output service influence degree information.

FIG. 7 is an explanatory view depicting an example of the service influence degree information. Referring to FIG. 7, the service influence degree information includes items of “device corresponding to risk factor”, and influence degrees imposed on respective user services for each risk factor.

Referring to FIG. 7, an influence degree imposed on a user service SV1 by the physical server PS1 is 183. An influence degree imposed on a user service SV2 and a user service SV3 by the physical server PS1 are 533 and 0, respectively.

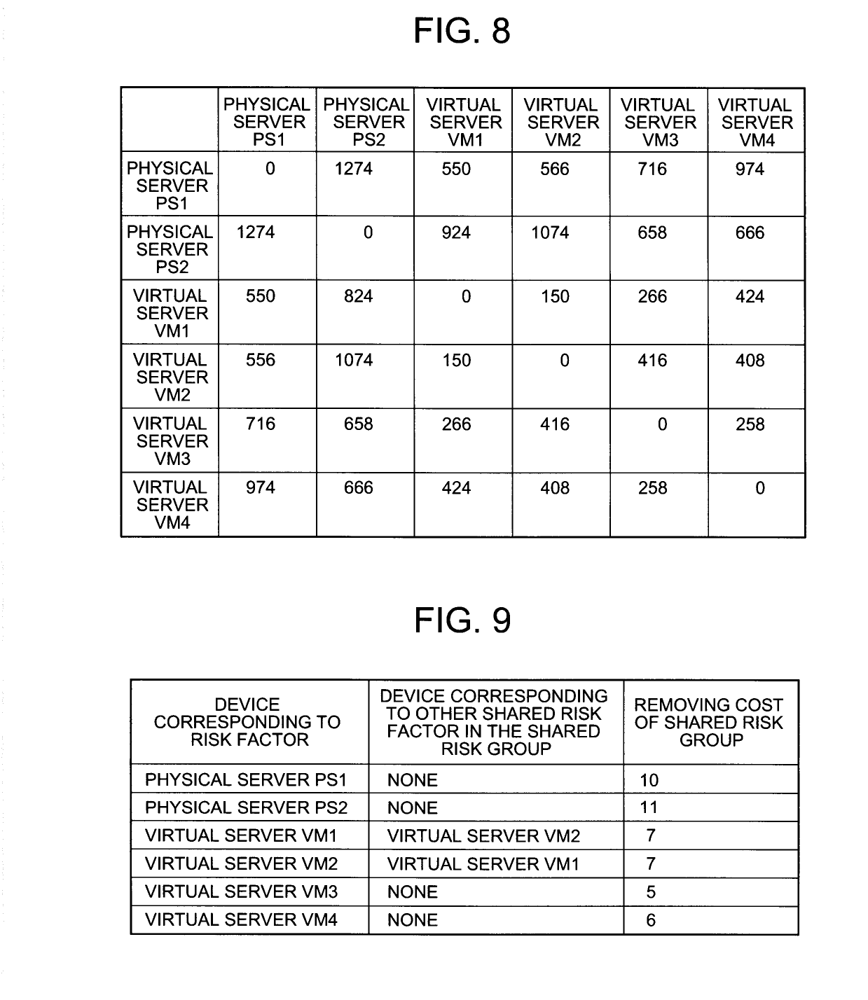

The risk factor distance calculation unit 102 calculates a distance between a pair of risk factors by using the information depicted in FIG. 7 for each pair of the risk factors. After this calculation, the risk factor distance calculation unit 102 outputs risk factor distance information. FIG. 8 depicts an example of the output risk factor distance information.

FIG. 8 is an explanatory view of an example of the risk factor distance information. Referring to FIG. 8, the risk factor distance information includes items of distances representing similarities between devices corresponding to risk factors for each pair of devices corresponding to risk factors.

Referring to FIG. 8, the distance between the physical server PS1 and the physical server PS2 is 1274. The distance between the physical server PS1 and the virtual server VM1 is 550.

The shared risk group determination unit 103 calculates a shared risk group and a cost for removing the shared risk group based on the information depicted in FIG. 8.

For example, when the shared risk group determination unit 103 inputs 250 as the maximum distance, each distance between the physical server PS1 and other risk factors is larger than 250 with reference to FIG. 8, wherefore no shared risk factor is contained in the shared risk group of the physical server PS1. The shared risk group of the physical server PS1 contains only the physical server PS1.

Accordingly, the cost for removing the shared risk group of the physical server PS1 corresponds to the cost for removing the physical server PS1. Referring to FIG. 4, the cost for removing the shared risk group of the physical server PS1 is 10.

Similarly, referring to FIG. 8, the distance between the virtual server VM1 and the virtual server VM2 is 150, and therefore is smaller than the maximum distance of 250. Each distance between the virtual server VM1 and risk factors other than the virtual server VM2 is larger than 250. Accordingly, the shared risk group of the virtual server VM1 contains the virtual server VM1 and the virtual server VM2.

The cost for removing the shared risk group of the virtual server VM1 corresponds to the sum of the cost for removing the virtual server VM1 and the cost for removing the virtual server VM2. Referring to FIG. 4, the cost for removing the shared risk group of the virtual server VM1 is 7.

When designation of all the risk factors is completed by repeating the foregoing processes, the shared risk group determination unit 103 outputs shared risk group information. FIG. 9 depicts an example of the output shared risk group information.

FIG. 9 is an explanatory view depicting an example of the shared risk group information. Referring to FIG. 9, the shared risk group information contains items of “device corresponding to risk factor”, “device corresponding to other shared risk factor and contained in shared risk group”, and “cost for removing shared risk group” for each risk factor.

The information depicts in FIG. 9 is shared risk group information when the maximum distance input by the shared risk group determination unit 103 is designated as 250.

The shared risk group removal determination unit 104 refers to the shared risk group information depicted in FIG. 9. Then, the shared risk group removal determination unit 104 determines that the shared risk group requiring the minimum removal cost is the shared risk group of a virtual server VM3 requiring a removal cost of 5.

The shared risk group removal determination unit 104 determines the shared risk group of the virtual server VM3 as the shared risk group to be removed. Then, the shared risk group removal determination unit 104 outputs information on the determined shared risk group of the virtual server VM3.

When the shared risk group determination unit 103 inputs the maximum distance of 500 by way of another example, risk factors positioned at smaller distances from the virtual server VM1 than 500 are the virtual server VM2, the virtual server VM3, and a virtual server VM4 with reference to FIG. 8. Accordingly, the shared risk group of the virtual server VM1 contains the virtual servers VM1 to VM4.

The cost for removing the shared risk group of the virtual server VM1 corresponds to the sum of the costs for removing the virtual server VM1, the virtual server VM2, the virtual server VM3, and the virtual server VM4. Referring to FIG. 4, the cost for removing the shared risk group of the virtual server VM1 is 18.

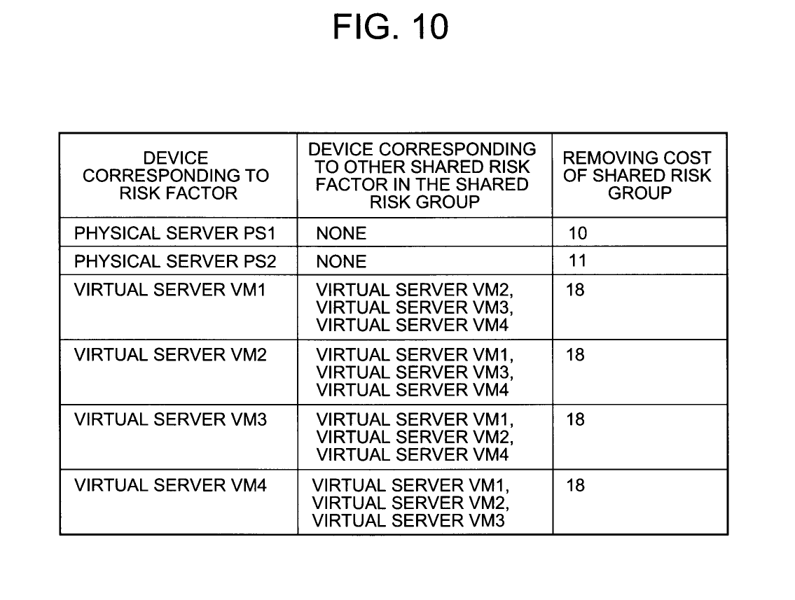

When designation of all the risk factors is completed by repeating the foregoing processes, the shared risk group determination unit 103 outputs shared risk group information. FIG. 10 depicts an example of the output shared risk group information.

FIG. 10 is an explanatory view depicting an example of the shared risk group information. The information depicted in FIG. 10 is shared risk group information when the maximum distance input by the shared risk group determination unit 103 is designated as 500.

The shared risk group removal determination unit 104 refers to the shared risk group information depicted in FIG. 10. Then, the shared risk group removal determination unit 104 determines that the shared risk group requiring the minimum cost for removing the shared risk group is the shared risk group of the physical server PS1 requiring a removal cost of 10.

The shared risk group removal determination unit 104 determines the shared risk group of the physical server PS1 as the shared risk group to be removed. Then, the shared risk group removal determination unit 104 outputs information on the determined shared risk group of the physical server PS1.

The shared risk group management system according to this exemplary embodiment is capable of collectively managing, as shared risk factors, risk factors which are likely to simultaneously influence normal operation of a device such as a virtual server, simultaneously cause failure of the device, and influence execution of a user service in a method which uses a mathematical model for analyzing availability, such as an operating ratio and a failure recovery time, of an information system, such as a cloud center, which provides online supply of server infrastructure constituted by virtual machines and physical servers to a number of tenant companies.

Moreover, the shared risk group management system according to this exemplary embodiment is applicable to such use which specifies a shared risk group desired to be collectively removed to facilitate management of shared risk factors in consideration of distances representing similarities between risk factors and costs for removing shared risk factors at the time of planning of risk factor removal for improvement of availability.

### Second Exemplary Embodiment

Next, a second exemplary embodiment according to the present invention is described. A configuration example of the shared risk group management system 100 according to the second exemplary embodiment of the present invention is similar to the configuration example discussed in the first exemplary embodiment, wherefore the same explanation is not repeated.

According to this exemplary embodiment, the shared risk group determination unit 103 is capable of inserting, into a shared risk group, a group of risk factors positioned at distances the sum of which is smaller than the maximum distance, as well as all risk factors each of which is positioned at a distance smaller than the maximum distance in step S111 in the flowchart depicted in FIG. 2.

Referring to FIG. 8, risk factors are the virtual server VM1 (distance 550), the virtual server VM2 (distance 566), the virtual server VM3 (distance 716), the virtual server VM4 (distance 974), and the physical server PS2 (distance 1274) when arranged in the ascending order of the distance from the physical server PS1.

Similarly, referring to FIG. 8, risk factors are the virtual server VM2 (distance 150), the virtual server VM3 (distance 266), the virtual server VM4 (distance 424), the physical server PS1 (distance 550), and the physical server PS2 (distance 924) when arranged in the ascending order of the distance from the virtual server VM1.

When the maximum distance is designated as 1000 in step S109, for example, the shared risk group of the physical server PS1 contains the virtual server VM1. At this time, the sum of the distances of the shared risk group of the physical server PS1 is 550.

According to this exemplary embodiment, the shared risk group of the virtual server VM1 contains the virtual server VM2, the virtual server VM3, and the virtual server VM4. This situation is produced from the fact that the sum of the distances from the virtual server VM1 to the virtual servers VM2 to VM4 calculated in the ascending order of the distance becomes 840 (150+266+424), which is smaller than 1000.

### Third Exemplary Embodiment

Next, a third exemplary embodiment according to the present invention is now described. A configuration example of the shared risk group management system 100 according to the third exemplary embodiment of the present invention is similar to the configuration example discussed in the first exemplary embodiment, wherefore the same explanation is not repeated.

According to this exemplary embodiment, the shared risk group removal determination unit 104 selects and outputs a plurality of shared risk groups each of which requires a removal cost not exceeding the maximum removal cost in step S113 in the flowchart depicted in FIG. 2, instead of determining a shared risk group requiring the minimum cost for removing the shared risk group as a shared risk group to be removed, and outputting this shared risk group.

Moreover, the shared risk group removal determination unit 104 is capable of arranging shared risk groups in the ascending order of the removal cost to determine the order of priorities in step S113.

When the maximum removal cost is 6, for example, the removal cost of the shared risk group of the virtual server VM3 (removal cost 5), and the removal cost of the shared risk group of the virtual server VM4 (removal cost 6) fall within the maximum removal cost with reference to FIG. 9. According to this exemplary embodiment, the shared risk group removal determination unit 104 determines these two shared risk groups as shared risk groups to be removed.

In addition, when the order of priorities are determined in the ascending order of the removal cost, the shared risk group of the virtual server VM3, and the shared risk group of the virtual server VM4 are arranged in this order.

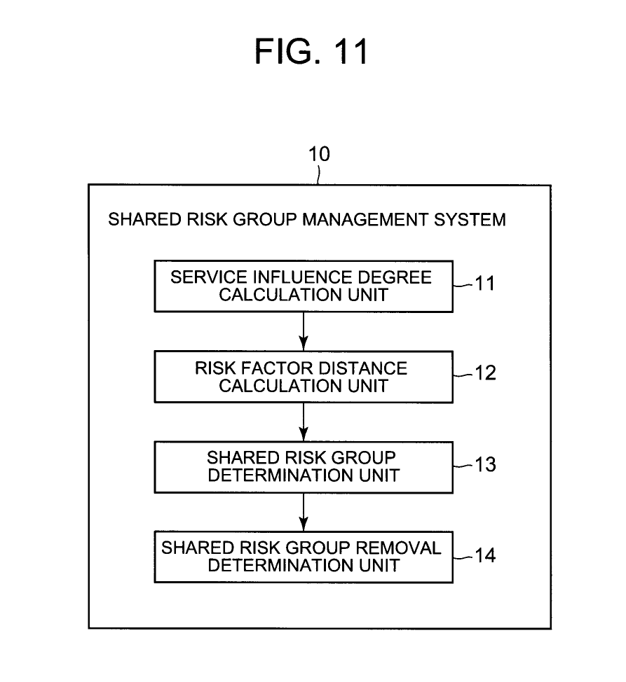

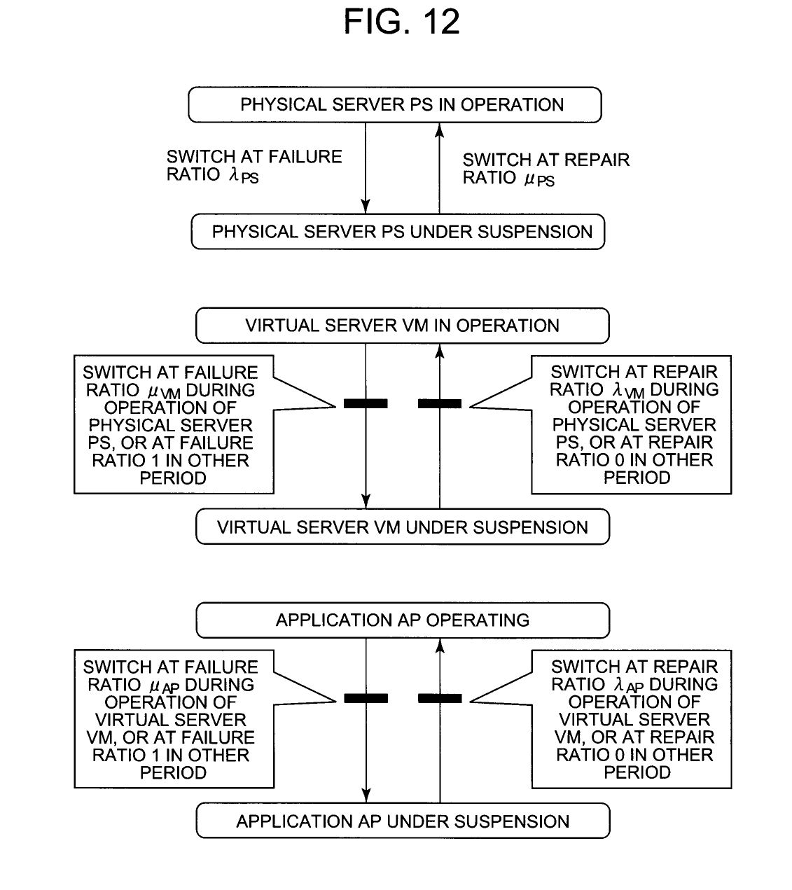

An outline of the present invention is now described. FIG. 11 is a block diagram depicting an outline of a shared risk group management system according to the present invention. A shared risk group management system 10 according to the present invention includes: a service influence degree calculation unit 11 (such as the service influence degree calculation unit 101) that calculates a service influence degree that is a degree of an influence imposed on each service by a risk factor which is likely to influence execution of the service, the service influence degree calculated for each of the risk factor; a risk factor distance calculation unit 12 (such as the risk factor distance calculation unit 102) that calculates a distance between risk factors for indicating a similarity between risk factors based on the service influence degree for each of the risk factors; a shared risk group determination unit 13 (such as the shared risk group determination unit 103) that determines, as a shared risk group, a group of risk factors each of which has a distance meeting a first condition between risk factors; and a shared risk group removal determination unit 14 (such as the shared risk group removal determination unit 104) that selects a shared risk group meeting a second condition from the shared risk groups, and determines the selected shared risk group as a shared risk group to be removed.

The shared risk group management system having this configuration is capable of measuring similarities between risk factors as distances, and determining a group of risk factors each of which is positioned at a distance meeting a predetermined condition as a result of the measurement to manage the group of risk factors as a shared risk group to be removed.

The first condition may be a condition that a distance between risk factors is smaller than a predetermined distance.

The shared risk group management system having this configuration is capable of managing a group of risk factors each of which is positioned at a distance within a designated distance range.

The first condition may be a condition that a sum of distances between risk factors is smaller than a predetermined distance.

The shared risk group management system having this configuration is capable of managing a group of risk factors positioned at distances the sum of which falls within a designated distance range.

The second condition may be a condition that a cost for removing the shared risk group, which cost corresponds to a sum of costs for removing risk factors contained in the shared risk group, becomes the minimum.

The removal cost is determined based on a man-hour for transferring a process executed by a virtual server to another virtual server, and a man-hour for constructing a new virtual server, for example. However, the removal cost may be given as other parameters.

The shared risk group management system having this configuration is capable of determining a shared risk group requiring the minimum shared risk group as a shared risk group to be removed.

The second condition may be a condition that a cost for removing the shared risk group, which cost corresponds to a sum of costs for removing risk factors contained in the shared risk group, is smaller than a predetermined value.

The shared risk group management system having this configuration is capable of determining a plurality of shared risk groups each of which requires a removal cost falling within a predetermined range as shared risk groups to be removed.

The shared risk group removal determination unit 14 may arrange shared risk groups in the ascendant order of the removal cost to indicate the order of priorities for removing a plurality of shared risk groups.

The shared risk group management system having this configuration is capable of determining shared risk groups to be removed in the ascending order of the removal cost.

The service influence degree calculation unit 11 may calculate the service influence degree by calculating influence degrees on all services for each risk factor based on risk factor information, target device characteristic information, and user service characteristic information.

The risk factor information may include items of risk factors, a list of devices influenced by risk factors, and removal costs.

The target device characteristic information may include items of parameters concerning failure, and parameters concerning recovery for each device.

The user service characteristic information may include items of a list of applications necessary for operations of user services for each user service.

The risk factor distance calculation unit 12 may calculate a similarity between risk factors based on a distance between service influence degrees.

The distance calculated by the risk factor distance calculation unit 12 may be a geometrical distance in Euclidean space.

This application claims priority to Japanese Patent Application No. 2013-107597, filed May 22, 2013, the entirety of which is hereby incorporated by reference.

The invention of the present application is not limited to the exemplary embodiments presented herein for the purpose of describing the invention of the present application. The configurations and details of the invention of the present application may include various modifications understandable by those skilled in the art within the scope of the invention of the present application.

### REFERENCE SIGNS LIST

10, 100 Shared risk group management system
11, 101 Service influence degree calculation unit
12, 102 Risk factor distance calculation unit
13, 103 Shared risk group determination unit
14, 104 Shared risk group removal determination unit
AP1 to AP6, APₖ Application program
PS1 to PS2, PSᵢ Physical server
SV1 to SV3, SVₗ User service
VM1 to VM4, VMⱼ Virtual server

What is claimed is:

1.-8. (canceled)

9. A shared risk group management system comprising:
a service influence degree calculation unit that calculates a service influence degree that is a degree of an influence imposed on each service by a risk factor which is likely to influence execution of the service, the service influence degree calculated for each of the risk factors;
a risk factor distance calculation unit that calculates a distance between risk factors for indicating a similarity between risk factors based on the service influence degree for each of the risk factors;
a shared risk group determination unit that determines a group of risk factors which has the distance between risk factors meeting a first condition, as a shared risk group; and
a shared risk group removal determination unit that determines a shared risk group meeting a second condition from the shared risk groups, as a shared risk group to be removed.

10. The shared risk group management system according to claim 9, wherein the first condition is a condition that a distance between risk factors is smaller than a predetermined distance.

11. The shared risk group management system according to claim 9, wherein the first condition is a condition that a sum of distances between risk factors is smaller than a predetermined distance.

12. The shared risk group management system according to claim 9, wherein the second condition is a condition that a cost for removing the shared risk group, which cost is a sum of costs for removing risk factors contained in the shared risk group, is the minimum.

13. The shared risk group management system according to claim 9, wherein the second condition is a condition that a cost for removing the shared risk group, which cost is a sum of costs for removing risk factors contained in the shared risk group, is smaller than a predetermined value.

14. The shared risk group management system according to claim 13, wherein a shared risk group removal determination unit arranges the shared risk groups in the ascending order of the removal cost to indicate the order of priorities for removing a plurality of shared risk groups.

15. A shared risk group management method comprising:
calculating a service influence degree that is a degree of an influence imposed on each service by a risk factor which is likely to influence execution of the service, the service influence degree calculated for each of the risk factors;
calculating a distance between risk factors for indicating a similarity between risk factors based on the service influence degree for each of the risk factors;
determining a group of risk factors which has the distance between risk factors meeting a first condition, as a shared risk group; and
determining a shared risk group meeting a second condition from the shared risk groups, as a shared risk group to be removed.

16. A non-transitory computer readable information recording medium storing a shared risk group management program that, when executed by a processor, performs a method for:
calculating a service influence degree that is a degree of an influence imposed on each service by a risk factor which is likely to influence execution of the service, the service influence degree calculated for each of the risk factors;
calculating a distance between risk factors for indicating a similarity between risk factors based on the service influence degree for each of the risk factors;
determining a group of risk factors which has the distance between risk factors meeting a first condition, as a shared risk group; and
determining a shared risk group meeting a second condition from the shared risk groups, as a shared risk group to be removed.

17. The shared risk group management system according to claim 10, wherein the second condition is a condition that a cost for removing the shared risk group, which cost is a sum of costs for removing risk factors contained in the shared risk group, is the minimum.

18. The shared risk group management system according to claim 11, wherein the second condition is a condition that a cost for removing the shared risk group, which cost is a sum of costs for removing risk factors contained in the shared risk group, is the minimum.

19. The shared risk group management system according to claim 10, wherein the second condition is a condition that a cost for removing the shared risk group, which cost is a sum of costs for removing risk factors contained in the shared risk group, is smaller than a predetermined value.

20. The shared risk group management system according to claim 11, wherein the second condition is a condition that a cost for removing the shared risk group, which cost is a sum of costs for removing risk factors contained in the shared risk group, is smaller than a predetermined value.
